(19) United States
(12) Patent Application Publication
(10) Pub. No.: US 2022/0032263 A1
(43) Pub. Date: Feb. 3, 2022

(54) COLORED ZEOLITE ADSORBENT

(71) Applicant: Arkema France, Colombes (FR)

(72) Inventor: Nicolas Serge, Pau (FR)

(73) Assignee: Arkema France, Colombes (FR)

(21) Appl. No.: 17/312,263

(22) PCT Filed: Dec. 4, 2019
(86) PCT No.: PCT/FR2019/052916

§ 371 Date: Jun. 9, 2021

(30) Foreign Application Priority Data
Dec. 13, 2018 (FR) 1872873

(51) Int. Cl. B01J 20/18; B01J 20/28; B01J 20/30; B01J 20/32; B01J 20/12; E06B 3/663; E06B 7/12

(52) U.S. Cl. CPC B01J 20/183; B01J 20/2803; B01J 20/3028; B01J 20/3042; B01J 20/3078; B01J 2220/42; B01J 20/3236; B01J 20/12; E06B 3/66361; E06B 7/12; B01J 2220/82; B01J 20/3204

(57) ABSTRACT

The present invention concerns a zeolitic adsorbent comprising a zeolitic agglomerate comprising at least one zeolite and at least one agglomeration binder, said agglomerate being coated with a coating comprising at least one pigment.

### CROSS-REFERENCE TO RELATED APPLICATIONS

This is the national phase of International Application No. PCT/FR2019/052916, filed 4 Dec. 2019, which claims priority to French Application No. FR 1872873, filed 13 Dec. 2018. The disclosure of each of these applications is incorporated herein by reference in its entirety for all purposes.

### FIELD OF THE INVENTION

The present invention concerns the field of zeolitic adsorbents and more particularly of agglomerated zeolitic adsorbents which can be used in diverse, dynamic or static, applications.

### BACKGROUND OF THE INVENTION

Zeolitic adsorbents, also called “molecular sieves” or simply “zeolites”, are nowadays widely known, being used in very many, diverse and varied, fields, ranging from catalysis to the separation of chemical compounds, on the basis of the adsorption properties of the zeolites, whether these be natural, artificial or synthetic.

Zeolites are usually aluminosilicates in crystalline form. These aluminosilicate crystals are generally very small-size crystals, of the order of a few nanometers to a few micrometers, and their handling and use are somewhat sensitive.

Zeolite crystals are therefore very often shaped, by various means, by compacting or more generally by agglomeration with what is termed an agglomeration binder and which may be organic or inorganic—examples include polymers and clays. The zeolite crystals agglomerated with an agglomeration binder are called “agglomerated zeolitic adsorbents”.

Agglomerated zeolitic adsorbents are variable in size, generally between a few micrometers and a few millimeters, and—due in particular to the agglomeration binder—have extremely advantageous mechanical strength properties, especially in terms of mechanical crush resistance or attrition resistance.

Agglomerated zeolitic adsorbents are usually used in closed, sealed-off places, and so are not generally visible to the user. On the face of it, then, their color and appearance are of little importance.

Agglomerated zeolitic adsorbents are therefore commonly in the form of beads or extrudates and are variable in color, ranging from white through gray shades to brown. There are, though, certain scenarios in which it would be desirable to have colored agglomerated zeolitic adsorbents available—the color being, for example, blue, red, yellow, green, black, et cetera.

Agglomerated zeolitic adsorbents of such kind with a color different from their “natural” color simply are not currently present in the market.

It might, however, prove very useful to have agglomerated zeolitic adsorbents available in diverse colors, more particularly in colors suited to the specific uses for which they are destined.

Accordingly, and to meet, for example, the demand of the agglomerated zeolitic adsorbents market for double glazing, the proposal is to prepare colored beads of molecular sieves such that the dusts generated by the beads are the same or at least similar in color to the window seals. The dusts possibly escaping from the aluminum strip and settling on the seals of the double glazing will therefore be less or minimally visible, or invisible, this being a significant aesthetic and quality advantage.

While there are already processes known for coating agglomerates of molecular sieves, in the form for example of coated beads, such processes fail to take account of the colored appearance of the beads. The coating of molecular sieves is in fact used primarily to reduce dusting; controlling the color of these molecular sieves, on the other hand, is a subject not ever broached.

Existing coating processes typically employ attapulgite clays and have proven effective in reducing dusting. The agglomerates obtained have the appearance, however, of beads a light beige in color after the activating step at 550° C. To be able to control the coloring of the activated molecular sieve agglomerates (i.e., after the activating step), then, it is necessary to develop coating formulations which result, after activation, in beads which first produce little dust and secondly have a well-defined and controlled color to any dusts there may be.

### SUMMARY OF THE INVENTION

Throughout the present invention, a range of coloration is defined using the well-known chromaticity coordinates of the CIE L*a*b* system (1976), defined thus:
the lightness L*, which adopts values between 0 (black) and 100 (reference white);
the parameter a* represents the value on a green→red axis from −120 to +120,
the parameter b* represents the value on a blue→yellow axis from −120 to +120.

It has now surprisingly been found that zeolitic agglomerates can be coated with colored compositions whose coloring remains controlled over all the steps in preparing said agglomerates, including during and/or after the final activating step, preferably after the final activating step. It has also been observed that the coating according to the invention usually has a high abrasion resistance, so leading to low levels of dust generated under normal usage conditions.

Moreover, in another major advantage of the present invention, the coating obtained by the process of the present invention has little or no detrimental effect on the adsorption properties, and especially the adsorption capacities, more particularly for adsorption of water.

Thus, and according to a first aspect, the present invention relates to a zeolitic adsorbent material comprising:
a zeolitic agglomerate comprising at least one zeolite and at least one agglomeration binder, and
said agglomerate being coated with a coating comprising at least one pigment.

The zeolitic adsorbent material coated with a coating comprising at least one pigment therefore has a specific coloration, due in particular to the pigment present in said coating. In one preferred aspect, the zeolitic adsorbent material of the present invention has a color whose component L* is preferably between 0 and 80, more preferably between 0 and 60, more preferably between 0 and 50, advantageously between 0 and 40.

With further preference, the zeolitic adsorbent material of the present invention has a color whose component a* is between −100 and +100, preferably between −80 and +80, more preferably between −60 and +60, advantageously between −40 and +40, more advantageously between −20 and +20.

In yet a further preference, the zeolitic adsorbent material of the present invention has a color whose component b* is between −100 and +100, preferably between −80 and +80, more preferably between −60 and +60, advantageously between −40 and +40, more advantageously between −20 and +20.

In one especially preferred aspect, the zeolitic adsorbent material of the present invention has a color within the following range:

L* between 0 and 40, a* between −20 and +20, and b* between −20 and +20.

In one embodiment of the invention, the coating has a thickness of between 10 μm and 1000 μm, preferably between 10 μm and 300 μm, more preferably between 10 μm and 150 μm, measured under the electron microscope, on a section of zeolitic adsorbent material according to the invention.

### DETAILED DESCRIPTION OF THE INVENTION

Said at least one zeolite in the adsorbent material according to the present invention may be any conventional type of adsorbent material, whether natural, synthetic or artificial in origin. For example, the zeolites that can be employed in the present invention are zeolites having an Si/Al atomic ratio of between 1 and 100, preferably between 1 and 50, more preferably between 1 and 20, very preferably between 1 and 10, advantageously 1 and 6.

In one preferred embodiment of the present invention, the zeolites have an average particle size of less than 20 μm, preferably less than 15 μm, and generally and advantageously more than 0.05 μm, preferably more than 0.1 μm. The average particle size is measured by laser diffraction using, for example, a Malvern® Mastersizer S instrument, standard NF ISO 13320 (2000).

Nonlimiting examples of zeolites employable in the present invention include LTA-type zeolites and FAU-type zeolites, preferably such as X faujasites, LSX faujasites, MSX faujasites, Y faujasites, et cetera. It will be appreciated that a mixture of two or more zeolites may be used. To do so is particularly advantageous when the aim is to modify the adsorption capacities and/or adsorption kinetics of the material according to the invention, the different types of zeolites each possessing specific adsorption capacities and kinetics.

In one embodiment of the invention, the amount of zeolite(s), present in the form of zeolite crystals, is preferably more than 65%, more preferably more than 70% by weight relative to the total weight of said adsorbent material, and this amount is less than 99%, preferably less than 95%, more preferably less than 90%, very preferably less than or equal to 85% by weight relative to the total weight of said adsorbent material.

In one embodiment of the invention, the amount of zeolite(s), present in the form of zeolite crystals, is between 65% and 99%, preferably between 65% and 95%, more preferably between 70% and 90%, advantageously between 70% and 85% by weight relative to the total weight of said adsorbent material.

Besides the one or more zeolites defined above, the material according to the invention comprises an agglomeration binder. The agglomeration binder may be of any type known to the skilled person, and more particularly selected from clays and inorganic binders commonly used in the zeolite field. In one especially preferred aspect, the agglomeration binder may contain a clay or mixtures of clays, such as, for example, bentonite, attapulgite, kaolin, et cetera, and also additives intended for example to aid agglomeration or promote hardening of the agglomerates formed.

The pigments (or dyes) which can be used in making the coating on the material of the present invention may be highly diverse in origin, provided their color corresponds to the target color of said material, after the implementation steps to be detailed later on below, and especially after the calcining step required for the activation of said zeolitic adsorbent material, which is carried out between about 450° C. and about 600° C. A pigment utilizable within the present invention may therefore have a certain color, a color which may be different in the end product, the material after calcining.

There may of course be advantage to using mixtures of different pigments, in any proportions, so as to have a greater number of color shades available, if necessary or if desired.

Pigments to have shown complete suitability for the needs of the present invention include on the one hand colorants of plant origin, such as those obtained by calcining various plants—nonlimiting examples are peach black, lamp black, wine black and on the other hand colorants of mineral origin—nonlimiting examples are vine black and mineral black.

It is also possible to use naturally colored clays such as, for example, Dead Sea black clay, or else organic dyes, such as, for example, those from the lignosulfonate class.

Consequently it is easy for the composition of the one or more pigments to be adapted to the coloring range intended for the activated agglomerates taking account of the possible change in color of the surface following heat treatment of the agglomerates, such as the activating step which is required in order to obtain adsorbent materials which are anhydrous and exhibit high mechanical strength.

The amount of pigment present in the material according to the invention may vary within wide proportions, and is dependent primarily on the desired coloration, while minimizing as effectively as possible any adverse impact on the intrinsic efficacy of the zeolitic adsorbent material. The amount of pigment present in the adsorbent material according to the invention is generally between 0.01% and 10% by weight, preferably between 0.1% and 1% by weight, relative to the total weight of the zeolitic adsorbent material according to the invention.

In one further embodiment, the adsorbent material according to the present invention may further comprise one or more additives, commonly used in compounding techniques. Nonlimiting examples of such additives may be selected from UV stabilizers, antioxidants, impact modifiers, phase-change materials (PCMs), flame retardants, odorant agents, et cetera.

In another aspect, the invention relates to the process for preparing the zeolitic adsorbent material as has just been defined, said process comprising the following steps:
a) mixing an agglomeration binder and at least one zeolite, and agglomerating and shaping the mixture by the methods known to the skilled person to give a zeolitic agglomerate;
b) coating the agglomerate prepared and shaped in step a) using a coating composition comprising at least one pigment;
c) drying the coated agglomerate obtained in step b) at a temperature generally of between 80° C. and 200° C., for example at about 120° C.;
d) then activating the agglomerate by calcining at a temperature of between 450° C. and 650° C., preferably between 500° C. and 600° C., for example at a temperature of about 550° C.; and
e) recovering the colored coated zeolitic adsorbent material.

The agglomeration step a) is entirely well known to the skilled person and is for example described in FR2424058, for the manufacture of zeolitic agglomerates in bead form.

The coating composition useful within the present invention comprises at least one pigment, and, in one preferred embodiment, the coating composition comprises at least one pigment and at least one binder which is preferably a porous binder. The binder is selected advantageously, for example and without limitation, from clays, such as those commonly used for preparing zeolitic agglomerates, and advantageously from bentonite, attapulgite, and kaolin.

Advantageously the one or more pigments are intimately mixed with the binder to form the coating composition, which usually takes the form of a more or less pulverulent solid.

The proportion of pigment(s) in the coating composition varies within wide proportions, according in particular to the desired final color, the particle size of the pigment, and the particle size of the binder. Generally speaking, the proportion by weight of pigment relative to the total weight of the coating composition is between 1% and 99%, preferably 1% and 50%, more preferably from 1% to 30%.

Particle coating methods are well known to the skilled person, and methods may be found for example in the work “Size Enlargement by Agglomeration” by Salle and Sauerländer, John Wiley & Sons, section 4.2.3.6: “Coating Techniques”, (1991).

One process especially suitable for the requirements of the present invention may comprise spraying a coating formulation onto the still-wet agglomerate obtained in step a). During this operation, it may be desirable or necessary to add an amount of water to ensure optimal adhesion of the coating composition to the surface of the agglomerate. This amount of water is readily adaptable by the skilled person.

This coating operation may be carried out in all types of apparatus appropriate for such an operation, as for example a rotating plate, drum, conveyor belt, vibrating belt, vibrating conveyor belt, et cetera.

The drying and activating operations are usually carried out in a kiln, with rotary kilns being especially appropriate for this type of operation.

The resultant zeolitic adsorbent material comprises a pigment, present in the coating enveloping the adsorbent. The material according to the invention may hence be used in all the applications for which it is useful, while also having the color hailing from the pigment present in the coating.

As an example, and purely by way of illustration, it is possible accordingly to prepare a material in the form of beads of zeolitic agglomerates with a color, more particularly a dark color, and especially the color black, the material being outstandingly suitable as a desiccant in double glazing which comprises perforated metal strips enabling contact of the moisture adsorber with the plane of air present between the two panes of the double glazing, and more particularly between the two panes of what is termed a double-glazed window.

Accordingly, and in a yet further aspect, the present invention relates to a double-glazed window comprising a zeolitic agglomerated material coated with a colored coating as has just been defined in the description of the present invention.

The invention will be better understood in light of the following examples, which are given purely by way of illustration and in no way limit the scope of the invention.

### EXAMPLES

### Water Adsorption Capacity

The water adsorption capacity of the activated beads is measured to verify that the coating has no detrimental effect on the dehydration efficacy of the adsorbent material; the water adsorption capacities of a coated and colored adsorbent material of the invention are compared with the adsorption capacities of an uncoated material, in an atmosphere with a fixed humidity of 10%.

The method for measuring the water adsorption capacity involves measuring the increase in weight of a sample of material placed in a sealed chamber with constant hygrometry and temperature for a time sufficient to attain saturation.

A sample of about 1 g of beads is placed for 48 hours in a chamber thermostated at 25° C. with 10% humidity, which corresponds to the atmosphere of an aqueous solution of sulfuric acid with a density of 1.554.

The water adsorption capacity expressed in weight % is given by [(P3−P2)/(P2−P1)]×100, where P1 represents the mass of the sample holder, P2 the initial mass of sample and sample holder, and P3 represents the mass after adsorption by the sample+sample holder.

### Measurement of Lab Color

The color according to the CIE-Lab reference system (L*a*b* system) is measured using the Minolta CR-300 colorimeter. Before the color measurements are conducted, calibration is performed using a reference color plate supplied with the measuring instrument. To measure the color of the materials, the material is placed in a small cavity where measurement takes place and the material is wedged with a piece of flat glass. The CIE-Lab color is measured by placing the measuring head flat against the glass and then taking the color measurement. The result is displayed after several seconds on the instrument screen.

### Example 1

A zeolitic adsorbent material is prepared by agglomerating crystals of zeolite 3A (NK30SP from Arkema) with an agglomeration binder (clay), using 25% by weight of agglomeration binder and 75% by weight of zeolite crystals.

This resulting agglomerated material is coated on a rotating plate using a mixture of Zeoclay attapulgite clay (sold by Arkema) (70 parts by weight) and natural iron oxide: “Vine Black pigment” from Moulin à Couleurs (30 parts by weight).

The coated agglomerate is subsequently dried at 200° C. for 2 hours, then activated at 550° C. for 1 hour.

The material obtained takes the form of black-colored beads with a mean diameter of 1.3 mm, covered with a coating having a thickness of between 50 μm and 100 μm. The color of said material is close to black, with the following L*a*b* values:
L*=32.75 a*=+10.72 b*=+9.15.

An adsorption test is carried out according to the “Water adsorption capacity” protocol described above, with the material obtained above, in comparison with an uncoated but otherwise identical zeolitic adsorbent. The results of the test are presented in Table 1 below:

TABLE 1

| Sample | % Water adsorption |
|---|---|
| Coated | 17.0 |
| Uncoated | 17.5 |

Hence it has been clearly demonstrated that coating an adsorbent material to impart a color to it, according to the present invention, does not in any way adversely affect the adsorption capacities of said zeolitic adsorbent material.

1. A zeolitic adsorbent material comprising:
a zeolitic agglomerate comprising at least one zeolite and at least one agglomeration binder,
the agglomerate being coated with a coating comprising at least one pigment.

2. The material as claimed in claim 1, having a color whose component L* is between 0 and 80.

3. The material as claimed in claim 1, wherein the coating has a thickness of between 10 μm and 1000 μm.

4. The material as claimed in claim 1, wherein the one zeolitic agglomerate comprises a zeolite selected from LTA-type zeolites and FAU-type zeolites.

5. The material as claimed in claim 1, wherein the amount of zeolite(s) is more than 65% relative to the total weight of the adsorbent material, and is less than 99% by weight relative to the total weight of the material.

6. The material as claimed in claim 1, wherein the agglomeration binder is selected from clays and inorganic binders.

7. The material as claimed in claim 1, wherein the pigment is selected from peach black, lamp black, wine black, vine black, mineral black, Dead Sea black clay, and organic dyes from the lignosulfonate class.

8. The material as claimed in claim 1, wherein the amount of pigment is between 0.01% and 10% by weight relative to the total weight of the material.

9. A process for preparing a zeolitic adsorbent material as claimed in claim 1, comprising:
a) mixing an agglomeration binder and at least one zeolite, and agglomerating and shaping the mixture to give a zeolitic agglomerate;
b) coating the agglomerate prepared and shaped in step a) using a coating composition comprising at least one pigment;
c) drying the coated agglomerate obtained in step b) at a temperature generally of between 80° C. and 200° C.;
d) then activating the agglomerate by calcining at a temperature of between 450° C. and 650° C.; and
e) recovering the colored coated zeolitic adsorbent material.

10. The process as claimed in claim 9, wherein the coating composition comprises at least one pigment and at least one binder.

11. A double-glazed window comprising a zeolitic agglomerated material as claimed in claim 1.
